(19) United States
(12) Patent Application Publication
(10) Pub. No.: US 2008/0195958 A1
(43) Pub. Date: Aug. 14, 2008

(54) Visual recognition of user interface objects on computer

(76) Inventor: Patrick J. Detiege, Sunnyvale, CA (US)

Correspondence Address: William C. Milks, III;RUSSO & HALE LLP, 401 Florence Street, Palo Alto, CA, 94301, US

(21) Appl. No.: 12/069,238

(22) Filed: Feb. 8, 2008

Related U.S. Application Data
(60) Provisional application No. 60/888,980, filed on Feb. 9, 2007.

(51) Int. Cl. G06F 3/048

(52) U.S. Cl. 715/765

(57) ABSTRACT

A visual recognition of user interface objects on computer to recognize and localize objects on a computer screen such as input fields, buttons, icons, check boxes, text, and/or any other basic elements. A system captures the screen to an image, analyzes the image, and creates a layout with new virtual objects of the screen. The system captures the screen on a time basis like a movie camera as a bitmap. From the bitmap, the system generates lists of lines found on the screen, in which each line has properties such as length, color, starting point, and angle, for example. From the lines, the system creates rectangles found on the screen. From the bitmap, the system also searches each text element on the screen, and converts each text element to Unicode text. From the bitmap, the lines, the rectangles, and the text found on the screen, the system creates virtual objects that represent a one-for-one correspondence with each object found on the screen.

### CROSS-REFERENCE TO RELATED PATENT APPLICATION

This application relates to U.S. Provisional Patent Application No. 60/888,980, filed on Feb. 9, 2007, entitled VISUAL RECOGNITION OF USER INTERFACE OBJECTS ON COMPUTER, the disclosure of which is hereby incorporated in its entirety by this reference.

### BACKGROUND OF THE INVENTION

1. Field of the Invention

The present invention relates generally to visual recognition of objects and, more particularly, the present invention relates to visual recognition of user interface objects in a computer system. Specifically, various embodiments of the present invention provide an apparatus and method using a computer system to recognize and localize objects on a computer screen such as input fields, buttons, icons, check boxes, text, and/or any other basic elements.

2. Description of the Prior Art

It will be appreciated that visual recognition of objects has been in use for many years. Computer systems are known to be used with an imaging device such as a video camera to recognize objects such as items on a conveyor belt or defects in manufactured products. However, visual recognition of objects is not known to have been specialized to recognize objects appearing in the user interface of a computer system.

The main problem with conventional visual recognition of objects is that known computer systems do not recognize objects on a computer screen or in computer applications. Another problem with conventional visual recognition of objects is that the computer systems that are utilized are very slow because they have a broad range of recognition capability and are thus too general. Another problem with conventional visual recognition of objects is that the computer systems that are utilized are not accurate enough.

While known devices may be suitable for the particular purpose which they address, they are not suitable to recognize and localize objects on a computer screen such as input fields, buttons, icons, check boxes, text, and/or any other basic elements. The main problem with conventional visual recognition of objects by known computer systems is that they do not recognize objects on a computer screen or in computer applications. Also, as indicated above, other problems are that such computer-based object recognition systems are very slow because they are much too general and they are not accurate enough.

In these respects, the visual recognition of user interface objects on computer according to the various embodiments of the present invention substantially departs from the conventional concepts and devices of the prior art. In so doing, the present invention provides a method and apparatus primarily developed for the purpose of recognizing and localizing objects on a computer screen such as input fields, buttons, icons, check boxes, text, and/or any other basic elements and thus overcomes the shortcomings of known prior art concepts and devices.

### SUMMARY OF THE INVENTION

In view of the foregoing disadvantages inherent in the known types of visual recognition of objects now present in the prior art, the present invention provides a new apparatus and method for visual recognition of user interface objects on computer wherein the same can be utilized to recognize and localize objects on a computer screen such as input fields, buttons, icons, check boxes, text, and/or any other basic elements.

Accordingly, a primary objective of the present invention is to provide visual recognition of user interface objects on computer that will overcome the shortcomings of the prior art devices.

Another objective of the present invention is to provide a visual recognition of user interface objects on computer to recognize and localize objects on a computer screen such as input fields, buttons, icons, check boxes, text, and/or any other basic elements.

An additional objective of the present invention is to provide a visual recognition of user interface objects on computer that recognizes objects generated by the user interfaces of computer systems and is not platform dependent.

A further objective of the present invention is to provide a visual recognition of user interface objects on computer that localizes on the screen with X and Y coordinates and size each object, for example, icons, buttons, text, links on browser, input fields, check boxes, radio buttons, list boxes, and other basic elements.

The general purpose of the present invention, which will be described subsequently in greater detail, is to provide a new visual recognition of user interface objects on computer that has many advantages over the visual recognition of objects known heretofore and many novel features that result in a new visual recognition of user interface objects on computer, which are not anticipated, rendered obvious, suggested, or even implied by any of the prior art, either alone or in any combination thereof.

To attain this end, one embodiment of the present invention generally comprises a system that captures a screen to an image, analyzes the image, and creates a layout with new virtual objects of the screen. In accordance with a preferred embodiment of the present invention, the system captures the screen on a time basis like a movie camera to a bitmap format. From the bitmap, the system generates a list of lines found on the screen, wherein each line has properties such as length, color, starting point, angle, and/or other properties. From the lines, the system creates rectangles found on the screen. From the bitmap, the system also searches each text element on the screen, and preferably converts each text element to Unicode text. From the bitmap, the lines, the rectangles, and the text found on the screen, the system creates virtual objects that represent a one-for-one correspondence with each object found on the screen.

There has thus been outlined, rather broadly, the more important features of a preferred embodiment of the present invention in order that the detailed description thereof may be better understood, and in order that the present contribution to the art may be better appreciated. There are additional features of the invention that will be described hereinafter.

In this respect, before explaining at least one embodiment of the present invention in detail, it is to be understood that the invention is not limited in its application to the details of construction and to the arrangements of the components set forth in the following description or illustrated in the drawing figures. The present invention is capable of being rendered in other embodiments and of being practiced and carried out in various ways. Also, it is to be understood that the phraseology and terminology employed herein are for the purpose of the description and should not be regarded as limiting.

Other objectives and advantages of the present invention will become obvious to the reader. It is intended that these objectives and advantages are within the scope of the present invention.

To the accomplishment of the above and related objectives, the present invention may be embodied in the form illustrated in the accompanying drawing figures, attention being called to the fact, however, that the drawing figures are illustrative only, and that changes may be made in the specific construction illustrated.

The foregoing and other objectives, features, and advantages of the present invention will become more readily apparent from the following detailed description of various embodiments, which proceeds with reference to the accompanying drawing.

### BRIEF DESCRIPTION OF THE DRAWING

Various other objectives, features, and attendant advantages of the present invention will become fully appreciated as the same becomes better understood when considered in conjunction with the accompanying drawing figures, in which like reference characters designate the same or similar parts throughout the several views, and wherein:

FIG. 1 is a functional block diagram of one embodiment of the system and method in accordance with the present invention.

FIG. 2, comprising FIGS. 2A through 2C, are views of internal images from the Line Analyzer (2) and the Rectangle Analyzer (3) shown in FIG. 1.

FIG. 3, comprising FIGS. 3A and 3B, is a view of internal images from the Text Analyzer (4) shown in FIG. 1.

FIG. 4 is a functional block diagram of the Object Analyzer (8) shown in FIG. 1.

FIG. 5 is a block diagram illustrating an example of a computer system in accordance with one embodiment of the present invention.

### DETAILED DESCRIPTION OF THE PREFERRED EMBODIMENTS

Turning now descriptively to the drawing figures, in which similar reference characters denote similar elements throughout the several views, the accompanying figures illustrate a visual recognition of user interface objects on computer, which comprises a system and method that capture the screen to an image, analyze the image, and create a layout with new virtual objects of the screen. A preferred embodiment of the system and method in accordance with the present invention capture the screen on a time basis like a movie camera to a bitmap format. From the bitmap, the system and method of the preferred embodiment generate a list of lines found on the screen, in which each line has properties such as length, color, starting point, angle, or other property. From the lines, the system and method of the preferred embodiment create rectangles found on the screen. From the bitmap, the system and method of the preferred embodiment also search each text element on the screen and convert each such text element to Unicode text. From the bitmap, the lines, the rectangles, and the text found on the screen, the system and method of the preferred embodiment create virtual objects that represent a one-for-one correspondence with each object found on the screen.

The present invention is particularly applicable to a computer-implemented software-based system and method for visually recognizing user interface objects on computer, and it is in this context that the various embodiments of the present invention will be described. It will be appreciated, however, that the user interface object visual recognition system and method in accordance with the various embodiments of the present invention have greater utility, since they may be implemented in hardware or may incorporate other modules or functionality not described herein.

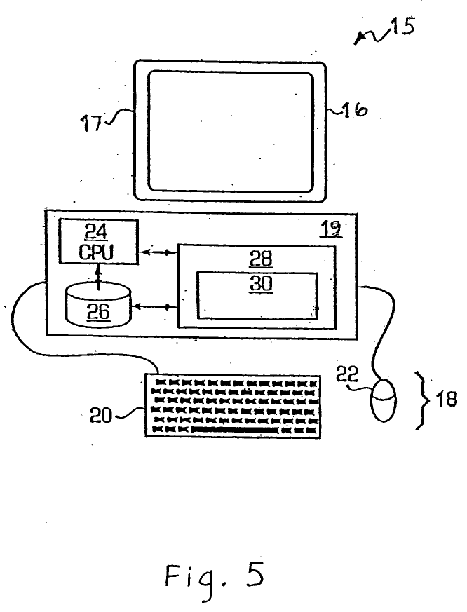

FIG. 5 is a block diagram illustrating an example of a user interface object visual recognition system 15 in accordance with one embodiment of the present invention implemented on a personal computer 16. In particular, the personal computer 16 may include a display unit 17, which may be a cathode ray tube (CRT), a liquid crystal display, or the like; a processing unit 19; and one or more input/output devices 18 that permit a user to interact with the software application being executed by the personal computer. In the illustrated example, the input/output devices 18 may include a keyboard 20 and a mouse 22, but may also include other peripheral devices, such as printers, scanners, and the like. The processing unit 19 may further include a central processing unit (CPU) 24, a persistent storage device 26, such as a hard disk, a tape drive, an optical disk system, a removable disk system, or the like, and a memory 28. The CPU 24 may control the persistent storage device 26 and memory 28. Typically, a software application may be permanently stored in the persistent storage device 26 and then may be loaded into the memory 28 when the software application is to be executed by the CPU 24. In the example shown, the memory 28 may contain a user interface object visual recognition software tool 30. The user interface object visual recognition software tool 30 may be implemented as one or more software modules that are executed by the CPU 24.

In accordance with various contemplated embodiments of the present invention, the user interface object visual recognition system 15 may also be implemented using hardware and may be implemented on different types of computer systems. The system in accordance with the various embodiments of the present invention may be run on desktop computer platforms such as Windows, Linux, or Mac OSX. Alternatively, the system may be run on cell phone, embedded systems, or terminals, or other computer systems such as client/server systems, Web servers, mainframe computers, workstations, and the like. Now, more details of an exemplary implementation of the user interface object visual recognition system 15 in software will be described.

Considered in more detail, the preferred embodiment of the system and method in accordance with the present invention capture a computer screen on a time basis like a movie camera. That is, a computer system takes a screen shot of the current screen at a predefined location and size. Alternatively, the image (i.e., screen shot) may be received from another device or from a bitmap file such as a jpeg, bmp, or png.

From the bitmap, the preferred embodiment of the system in accordance with the present invention generates a list of lines found on the screen, in which each line has properties such as length, color, starting point, angle, or other property. From the bitmap based on the screen shot, this system module generates a list of lines. The bitmap is scanned horizontally until the color changes enough and then creates a line object and adds the line to an output list. The same bitmap is also scanned vertically using the same process. The result is a list of lines that preferably contain: the coordinates X, Y, Width, Height, and average color of the line. An alternative is to use a high pass filter and create a line from end to end.

From the lines, the preferred embodiment of the system in accordance with the present invention finds rectangles on the screen. From the list of lines, this system module generates a list of rectangles. For each line, the preferred embodiment of the system and method in accordance with the present invention find the closest line perpendicular at the end of a given line, and repeat the process three times in order to create a rectangle. If a rectangle is found, the preferred embodiment of the system and method in accordance with the present invention add the rectangle to the list and set the properties X, Y, Width, Height, and average color inside. Alternatively, the rectangles can be built directly by analyzing the pixels on the screen and searching for a path with the same color.

From the bitmap, the preferred embodiment of the system and method in accordance with the present invention also search each text element on the screen, and preferably convert each such text element to Unicode text. From the bitmap based on the screen shot, this system module generates a list of text. A high pass filter generates a bitmap with the edges of objects, and a low pass filter generates the shape of each text element on the screen. A pixel scan generates the boundaries of each text element. The bitmap of the text is then sent to an optical character recognition (OCR) module, and the content is written back to the text object. Each text object in the list of text generated by this system module preferably contains: bounds of text on the screen and the code of each character of the text in Unicode UFT-8 coding. Alternatively, the text can be found by scanning the image from the top to the bottom and looking for blank spaces.

From the bitmap, the lines, the rectangles, and the text found on the screen, the preferred embodiment of the system and method in accordance with the present invention create virtual objects that represent a one-for-one correspondence with each object found on the screen. From the list of lines, rectangles, and text elements, the preferred embodiment of the system and method in accordance with the present invention make a list of objects that describe the screen. A Data Base (DB) contains training objects that this system module is intended to find. Each object in this DB has properties based on lines, rectangles, and/or text in order to describe the object. For example, a list box is described as a rectangle that contains a square rectangle on the right or on the left and with an icon in it. The output is the list of objects found on the screen and their location on the screen. Alternatively, the objects on the screen can be found by comparing predefined bitmaps with the screen at any location. However, this alternative requires considerable CPU time.

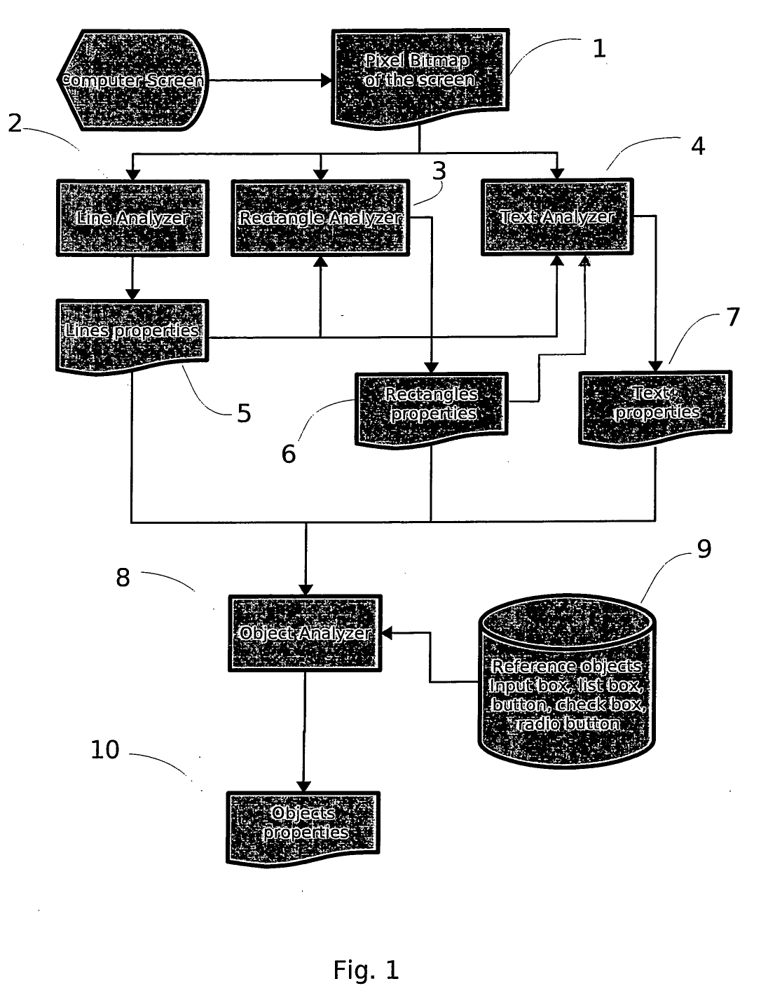

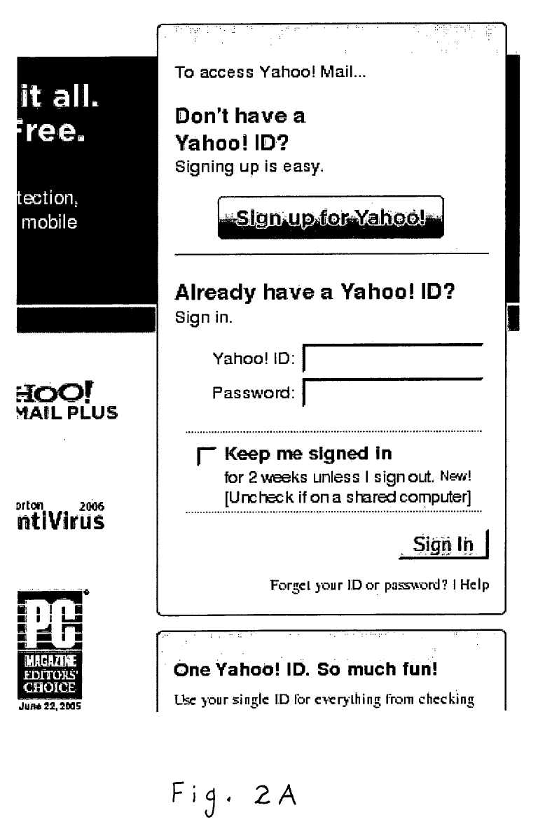

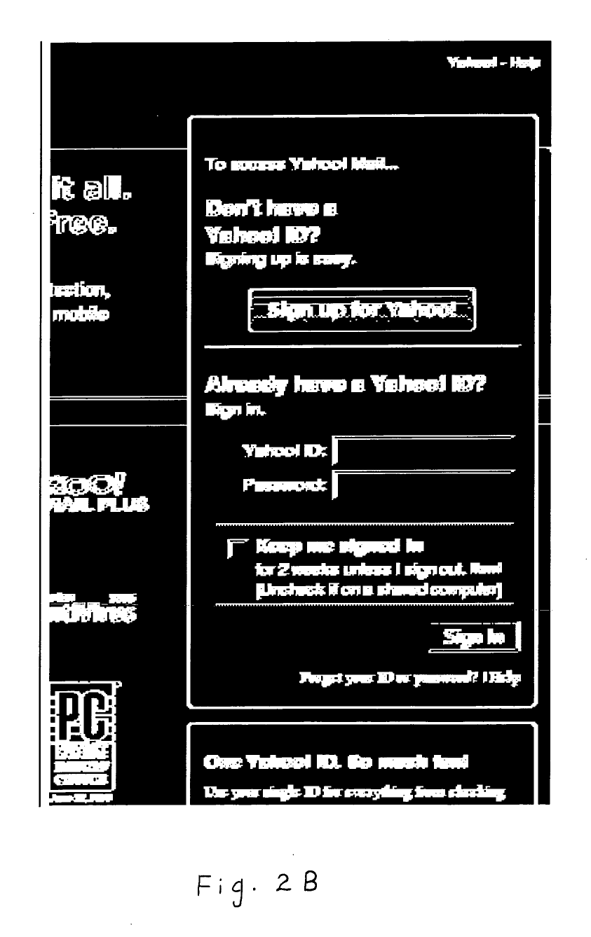

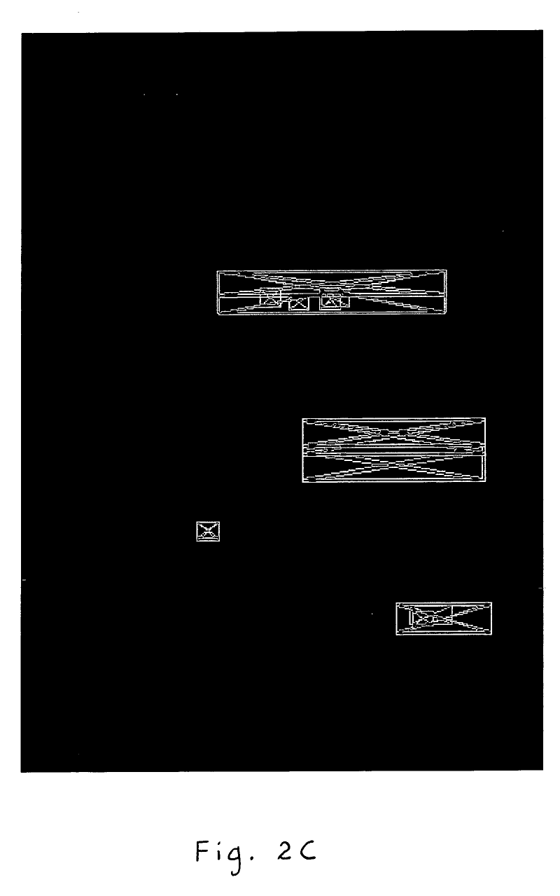

Considered in more detail, a pixel based image, for example, as illustrated in FIG. 2A, is received as illustrated at (1) in FIG. 1 of the drawing. This image illustrated in FIG. 2A is preferably a bitmap coming from a screen capture of the screen or from any file containing a bitmap image. This image can be an RGB colored or black and white gray level. The image (1) is supplied to a Line Analyzer (2), to a Rectangle Analyzer (3), and to a Text Analyzer (4).

The Line Analyzer (2) scans horizontally each pixel of the image, and when the color distance of the next pixel is greater than a predefined value, a horizontal line is created, for example, as illustrated in FIG. 2B. This line is added to a Line Properties (5) list. The process continues with the next pixel until the end of the scan line. When the end of the scan line is reached, the process continues with the next scan line until the end of the image is reached.

The Rectangle Analyzer (3) is supplied with the Lines Properties (5) list and the image (1). From each line in the Lines Properties (5) list, the process searches in the same list (5) for a line that is perpendicular (90 degrees) to the end of the currently selected line; when the line is found, the process continues for the next two lines in order to form a rectangle. When a rectangle is created, for example, as illustrated in FIG. 2C, the average color of its interior is computed from the image (1) and stored along with the location X, Y, and size into the Rectangle Properties (6) list. The rectangles that are too small to be an input, or are too large, are removed from the list.

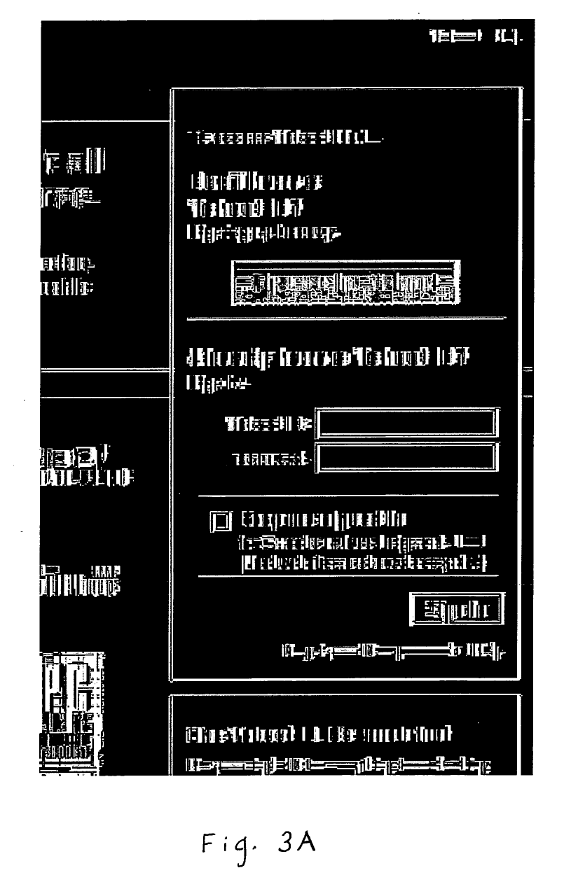

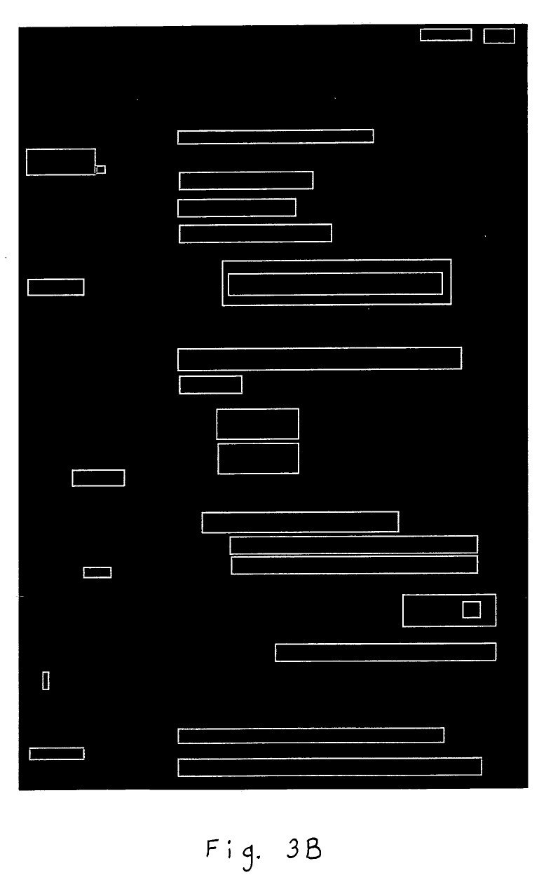

The Text Analyzer (4) is also supplied with the image (1), lines in the Lines Properties (5) list, and rectangles in the Rectangle Properties (6) list. The rectangles too small to contain a text element or too big are removed. The image (1) is processed by a high pass filter, for example, as illustrated in FIG. 3A, followed by a low pass filter and a system module that determines the bounds for each pixel from the output of the low pass filter. Text elements appearing in the image, as well as text associated with a line, for example, a link, and each rectangle containing text, for example, as illustrated in FIG. 3B, are sent to an OCR software module in order to retrieve the text, and the resulting text is added into the Text Properties (7) list shown in FIG. 1.

As shown in FIG. 1, an Object Analyzer (8) is supplied with Lines Properties (5), Rectangle Properties (6), and Text Properties (7) and produces a list of objects seen in the image (1). A data base Reference of Objects (9) contains the description of objects to be recognized in the image (1).

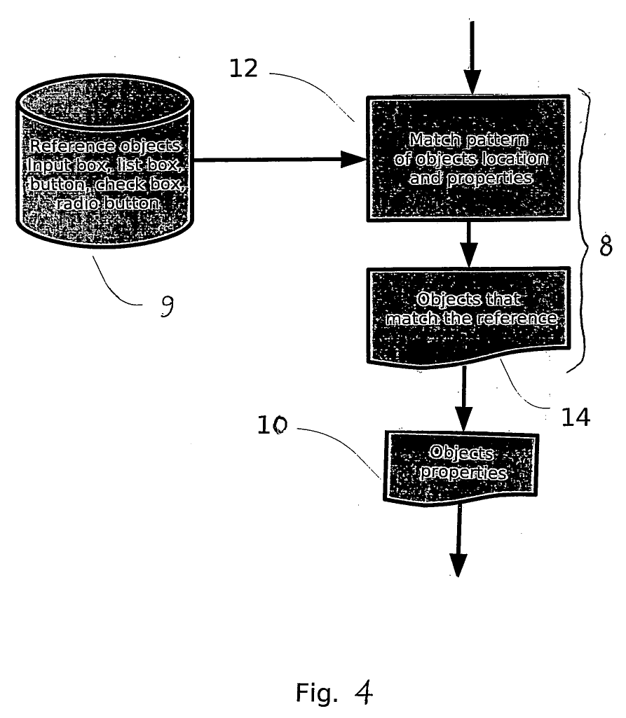

Referring now to FIGS. 1 and 4, the Object Analyzer (8) searches each Rectangle Properties (6) for a match in the data base (9). Each property of rectangle (6) is compared with each property of each reference object contained in the data base (9). The result is a percentage of match (12) for each reference, the best result wins, and a new object (14) is created in the Object Properties list (10) with the correct type of object (input box, list box, button, etc.), the location in the image (1), and the color.

As to a further discussion of the manner of usage and operation of the present invention, the same should be apparent from the above description. Accordingly, no further discussion relating to the manner of usage and operation will be provided.

With respect to the above description then, it is to be realized that the optimum relationships for the parts of the invention, to include variations in form, function, and manner of operation, arrangement and use, are deemed readily apparent and obvious to one skilled in the art, and all equivalent relationships to those illustrated in the drawing figures and described in the specification are intended to be encompassed by the present invention.

Therefore, the foregoing is considered as illustrative only of the principles of the invention. Further, since numerous modifications and changes will readily occur to one skilled in the art, it is not desired to limit the invention to the exact construction and operation shown and described, and accordingly, all suitable modifications and equivalents may be resorted to, falling within the scope of the present invention. Accordingly, the scope of the present invention can only be ascertained with reference to the appended claims.

What is claimed is:

1. An apparatus for visual recognition of user interface objects on a screen of a computer, comprising:
a system module to capture the screen to an image;
a system module to analyze the image; and
a system module to create a layout with new virtual objects of the screen;
wherein the apparatus is utilized to recognize and localize objects on a computer screen comprising input fields, buttons, icons, check boxes, text, or other basic element.

2. The apparatus of claim 1 wherein the capture system module captures the screen on a time basis to a bitmap format.

3. The apparatus of claim 2 wherein from the bitmap, the analysis system module generates a list of lines found on the screen, wherein each line has properties comprising at least one of the properties selected from among the properties length, color, starting point, and angle or other property.

4. The apparatus of claim 3 wherein from the lines, the analysis system module creates rectangles found on the screen.

5. The apparatus of claim 1 wherein from the bitmap, the analysis system module searches each text element on the screen and converts each text element to Unicode text.

6. The apparatus of claim 1 wherein the layout creation system module creates virtual objects that represent a one-for-one correspondence with each object found on the screen.

7. The apparatus of claim 1 wherein the capture system module takes a screen shot of the current screen at a predefined location and size, receives the image from another device, or receives the image as a bitmap file comprising a jpeg, bmp, or png.

8. The apparatus of claim 2 wherein the analysis system module scans the bitmap horizontally until a color changes enough and then creates a line object and adds the line to an output list and also scans the bitmap vertically using the same process, and wherein the result is a list of lines and at least one associated property for each line selected from among the properties consisting of X, Y coordinates, Width, Height, and average color of the line.

9. The apparatus of claim 2 wherein the analysis system module uses a high pass filter to create a line from end to end.

10. The apparatus of claim 4 wherein for each line, the analysis system module finds a closest line perpendicular at the end of a given line and repeats the process three times in order to create a rectangle and adds the rectangle to a list and sets at least one property for each rectangle selected from among the properties consisting of X, Y coordinates, Width, Height, and average color inside.

11. A method for visual recognition of user interface objects on a screen of a computer, comprising the steps of:
capturing the screen to an image;
analyzing the image; and
creating a layout with new virtual objects of the screen;
thereby recognizing and localizing objects on a computer screen comprising input fields, buttons, icons, check boxes, text, or other basic element.

12. The method of claim 11 wherein the step of capturing the screen comprises capturing the screen on a time basis to a bitmap format.

13. The method of claim 12 wherein from the bitmap, the step of analyzing the image comprises generating a list of lines found on the screen, wherein each line has properties comprising at least one of the properties selected from among the properties length, color, starting point, and angle or other property.

14. The method of claim 13 wherein from the lines, the step of analyzing the image comprises creating rectangles found on the screen.

15. The method of claim 11 wherein from the bitmap, the step of analyzing the image comprises searching each text element on the screen and converting each text element to Unicode text.

16. The method of claim 11 wherein the step of creating the layout comprises creating virtual objects that represent a one-for-one correspondence with each object found on the screen.

17. The method of claim 11 wherein the step of capturing the screen comprises taking a screen shot of the current screen at a predefined location and size, receiving the image from another device, or receiving the image as a bitmap file comprising a jpeg, bmp, or png.

18. The method of claim 12 wherein the step of analyzing the image comprises scanning the bitmap horizontally until a color changes enough and then creating a line object and adding the line to an output list and also scanning the bitmap vertically using the same process, and wherein the result is a list of lines and at least one associated property for each line selected from among the properties consisting of X, Y coordinates, Width, Height, and average color of the line.

19. The method of claim 12 wherein the step of analyzing the image comprises using a high pass filter to create a line from end to end.

20. The method of claim 14 wherein for each line, the step of analyzing the image comprises finding a closest line perpendicular at the end of a given line and repeating the process three times in order to create a rectangle and adding the rectangle to a list and setting at least one property for each rectangle selected from among the properties consisting of X, Y coordinates, Width, Height, and average color inside.
